(19) United States
(12) Patent Application Publication
(10) Pub. No.: US 2006/0140605 A1
(43) Pub. Date: Jun. 29, 2006

(54) Insertion ring step-down apparatus

(76) Inventor: Jerome Klein, Island Park, NY (US)

Correspondence Address: James M. Loeffler, Esq. PLLC;Courthouse Corporate Center, Suite 6800, 320 Carleton Avenue, Central Islip, NY, 11722, US

(21) Appl. No.: 11/286,645

(22) Filed: Nov. 25, 2005

Related U.S. Application Data
(60) Provisional application No. 60/630,711, filed on Nov. 24, 2004.

(51) Int. Cl. G03B 17/00

(52) U.S. Cl. 396/71

(57) ABSTRACT

A method and apparatus that allows a ring to be inserted into the primary devices lens element or adapter without changing the offset (i.e., the distance between the camera and the lens along the optical path). This can be at the ocular or recording end of lenses. The ring can be hand turned and gently tightened with a key similar to a spanner wrench. The ring will maintain it's place and location when the amount of pressure applied to the accessory is less then that applied to the ring. When the insertion ring is in place, the screw mount diameter of the primary device is smaller without adding additional unnecessary offset when mounting the accessory. The present application covers the usage, design and manufacture of insertion rings, insertion ring keys and any modifications to the primary device.

### CROSS-REFERENCE TO RELATED APPLICATIONS

This application claims the benefit of U.S. Provisional Application No. 60/630,711, filed Nov. 24, 2004.

### BACKGROUND OF THE INVENTION

1. Field of the Invention

The present invention relates to apparatus for use with camera lens systems, and, more specifically, to a step-down ring for use with interchangeable camera lenses.

2. Description of the Background Art

In general, the use of step-down rings is known in the art. However, the configuration of the known rings has its disadvantages. That is, screw in type rings have been used in cylinders to successfully decrease the diameter of the primary lens receiving device, but a disadvantage with the prior art rings was that the prior art rings also increased the offset along the optical path between the camera's lens element and the camera modifying item such as an add on filter, augment lens or hood. To date, this has been an acceptable approach because it solved a problem (i.e., the ring enabled the use of various lenses, etc.) and did not require a tool. However, with the invention of more precise lenses (e.g., zoom lenses), the distances along the optical path between two or more optical elements are now more critical because of the increased potential for internal lens flares.

Accordingly, there is a need in the art for a step-down ring which may be utilized with the additional components used in the field of photography which does not adversely alter the distance along the optical path between the camera and the new lens.

### SUMMARY OF THE INVENTION

It is an object of the present invention to provide an insertion step-down method and apparatus that allows rings to be inserted into the primary device's lens element or adapter without changing the offset. The ring can be hand turned and gently tightened with a key similar to a spanner wrench. The ring will maintain its place and location when the amount of pressure applied to the accessory installation into the ring opening, is less then that applied to the insertion ring. When the insertion ring is in place, the screw mount diameter of the primary device is smaller without adding additional unnecessary offset when mounting the accessory.

The insertion step-down system described herein modifies the adapter's front mount and has a special insertion ring with a key. The adapter is produced with the maximum usable diameter threads for the specific camera, a screw-stop for that size and a second stop for the insertion rings. Insertion rings with different smaller threads are disclosed that allow the camera owner to change the front diameter to a variety of smaller diameters without changing the lens offset.

The invention is not limited to the above-described embodiments, and various changes are possible without departing from the principles set forth herein. Furthermore, the embodiments include the invention at various stages, and various inventions can be extracted by properly combining multiple disclosed constructional requirements. There are many applications of this design. Filters that normally look like step rings with glass could be mounted closer the front element of cameras, by surrounding the filter glass with the metal insertion ring. All that is needed is key slots in the metal surrounding the filter and a second stop located between the thread area and the outside lip. Lens coupling rings that attach two lenses front to front could be made thinner reducing the distance between their front elements.

The above is a brief description of some deficiencies in the prior art and advantages of the present invention. Other features, advantages and embodiments of the invention will be apparent to those skilled in the art from the following description, drawings and claims.

### BRIEF DESCRIPTION OF THE DRAWINGS

The invention will become more clearly understood from the following detailed description in connection with the accompanying drawings, in which:

FIG. 1 is a side view illustrating an adapter in accordance with an embodiment of the present invention;

FIG. 2 is a side view illustrating a ring in accordance with an embodiment of the present invention;

FIG. 3 is a side view illustration a key for use with the ring of FIG. 2, in accordance with an embodiment of the present invention;

FIG. 4 is a top plan view of the ring illustrated in FIG. 2;

FIG. 5 is a bottom plan view of a ring in accordance with an embodiment of the present invention;

FIG. 6 is a top plan view of a ring in accordance with an embodiment of the present invention;

FIG. 7 is a side view in cross-section of a ring in accordance with an embodiment of the present invention;

FIG. 8 is a front view of a key tool in accordance with an embodiment of the present invention; and

FIG. 9 is a side view of a key tool in accordance with an embodiment of the present invention.

### DETAILED DESCRIPTION OF THE PREFERRED EMBODIMENTS

The following description is presented to enable one of ordinary skill in the art to make and use the invention and is provided in the context of a patent application and its requirements. Various modifications to the preferred embodiments will be readily apparent to those skilled in the art and the generic principles herein may be applied to other embodiments. Thus, the present invention is not intended to be limited to the embodiment shown but is to be accorded the widest scope consistent with the principles and features described herein.

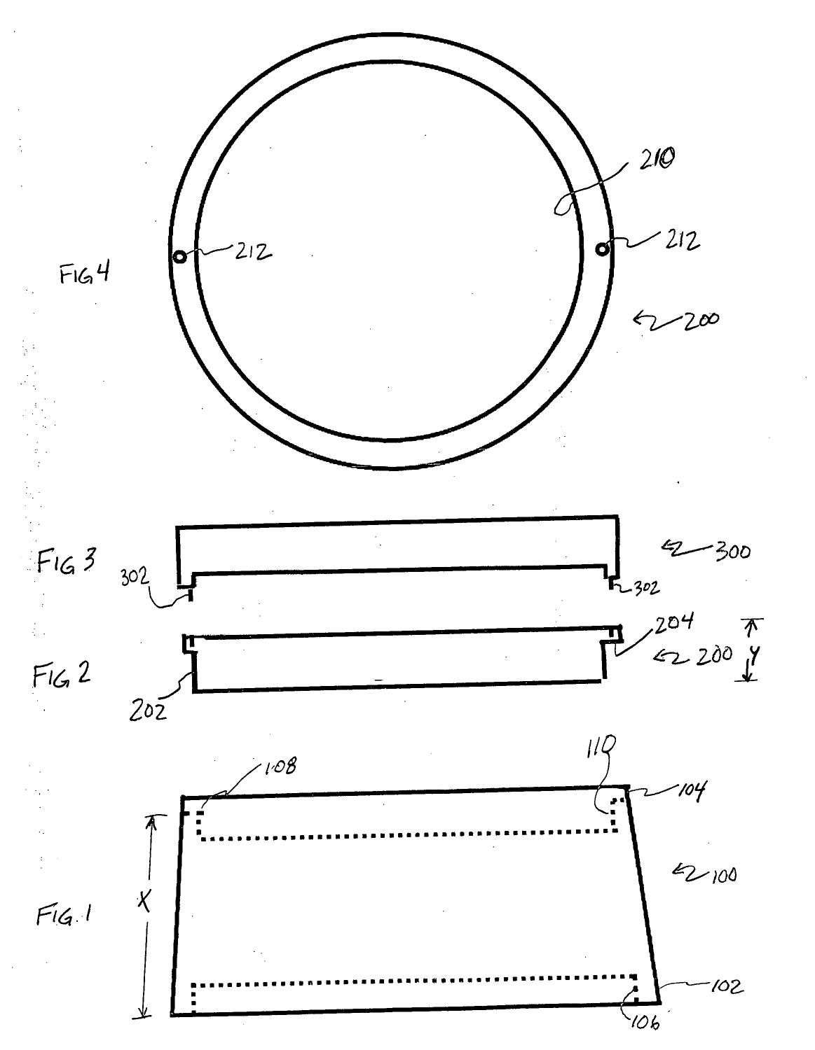

Referring now to the drawings, and first to FIGS. 1-4, the components of an insertion ring step-down apparatus is illustrated in accordance with the present invention. The components include an adapter 100, a ring 200 and a key tool 300.

A standard adapter 100 is a substantially cylindrical shaped device, known as an adapter, tube or adapter tube. The purpose of the adapter is to facilitate the attachment of different add on accessories that could not be attached for one or more of the following reasons: The camera's lens front did not have threads for added accessories. The weight of certain accessories would damage the lens when connected.

Accordingly, a camera owner wishing to use said accessories will purchase an adapter. The adapter will typically come with back end threads that fit the camera body and when installed will cover the stationary or moving lens allowing the accessory to be placed within the smallest distance to the lens without contact. The adapter will come with a fixed diameter size at the front end. This fixed diameter size limits the user to specific mount diameter accessories. If the user wanted to use different mount diameter accessories, they had two choices. They could purchase what is commonly know in the industry as step-down rings or a second adapter tube with a different front mount diameter. The second adapter solves the problem but doubles the investment and takes up additional space in the accessory bag. The step rings cost less, takes up less accessory space, but changes the displacement distance between the accessory and the camera's front lens element. The added displacement is caused by additional metal used for a finger grab to facilitate inserting and removing the step-down ring.

Turning now to the present invention and initially to FIG. 1, FIG. 1 illustrates the side of the adapter 100 milled and configured in accordance with the present invention. Adapter 100 has a first end portion 102 and a second end portion 104. The first end portion 102 defines a plurality of threads 106 on an inner surface thereof for thread ably engaging a camera (not shown). The outer most surface of the first end portion 102 of adapter 100 defines a circumferential lip which functions as stopping point when adapter 100 is screwed to a camera.

A circumferential shoulder 108 is formed adjacent the inner surface of the second end portion 104. Shoulder 108 prevents the items which are screwed into adapter 100 from entering too far into adapter 100. This facilitates mounting of original size accessories (for example, lenses) without falling in and keeps them at the correct distance ‘x’ from the front lens of the camera (not shown). Moving inward from the distal end portion 104, a milled depression slightly larger then the original diameter but smaller then the adapter lip may be formed, this is the stop for insertion rings with smaller diameters.

Referring now to FIGS. 1 and 2, ring 200 defines a plurality of threads 202 around an outer periphery of ring 200. Threads 202 are configured and dimensioned to threadably engage threads 110 defined on an inner surface of adapter 100.

The ring 200 also defines a plurality of threads 210 on an inner surface thereof. The diameter defined by threads 210 is less than the diameter which is defined by the outer threads 202. Accordingly, ring 200 converts the opening dimension of the second end portion 104 of adapter 100 from a first diameter to a second diameter wherein the magnitude of the first diameter is greater than the magnitude of the second diameter.

Ring 200 defines a circumferential shoulder 204. Shoulder 204 engages shoulder 108 when threads 202 fully engage threads 110. From a top view of ring 200, the threads 202 are not visible since they are set back under the circumferential shoulder 204. The diameter of circumferential shoulder 204 is slightly larger than the diameter of threads 202 and ring 200 is dimensioned and configured to fit within the end portion 104 of adapter 100. Also, advantageously, in accordance with the present invention, the thickness ‘y’ of ring 200 is dimensioned such that the ring 200 does not extend beyond the second end portion 104 of the adapter 100. Therefore, when the new lens is added, the distance from the camera to the new lens, along the optical path, is not increased. The rings in the prior art extend beyond the edge of the second end portion 104 of the adapter 100, thereby extending the distance along the optical path between the new lens and the camera.

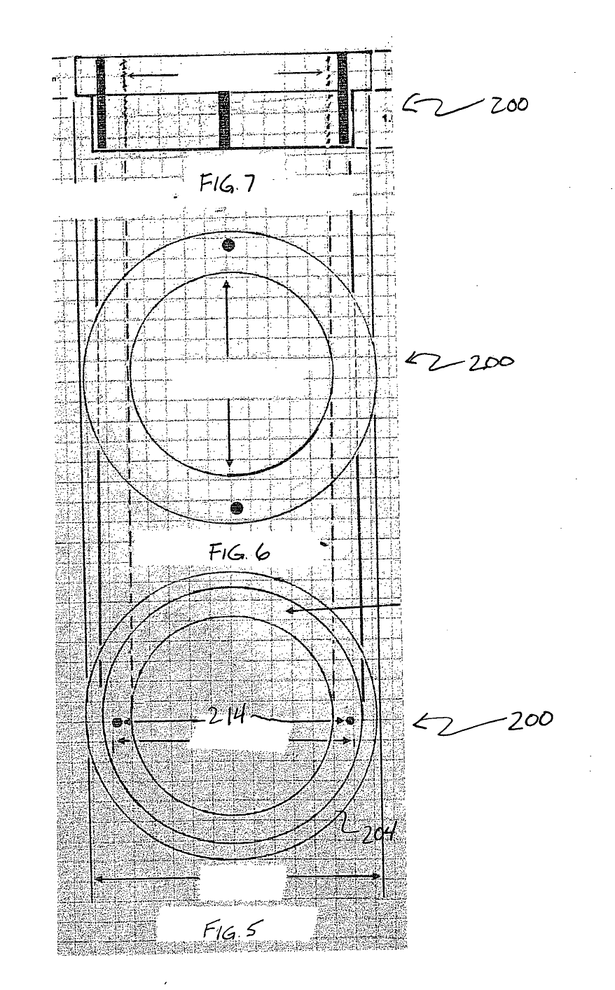

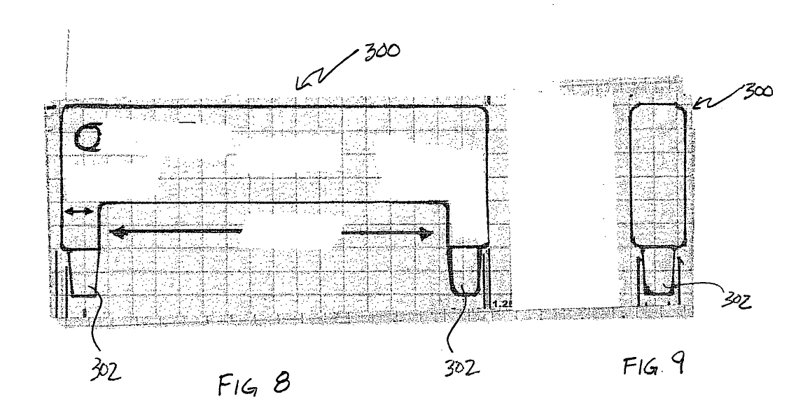

Referring now to FIG. 4, a top view of the insertion ring 200 is illustrated. As shown, there are no finger holes for inserting or removing the ring. The ring may be inserted by hand, with the final tightening performed with an insertion key 300, as shown in FIG. 3, in accordance with the present invention. That is, the tool 300 includes a pair of posts 302 configured and dimensioned to engage holes 212 formed in ring 200. The tool 300 may be utilized to tighten or loosen the ring.

FIG. 5 shows the bottom or back of the insertion ring 200. The circumferential shoulder 204 is slightly larger than the original thread is now visible sits in the insertion ring stop and insures the same offset. The original thread is above the lip and secures the ring in place. The additional key stops 214 illustrated in FIG. 5 are provided for use if the ring becomes stuck on the accessory. FIG. 6 illustrates a top view of ring 200. FIG. 7 is a side view in cross-section of a ring in accordance with an embodiment of the present invention.

FIGS. 8 and 9 are front and side views of a key tool in accordance with an embodiment of the present invention.

Although the present invention has been described in accordance with the embodiments shown, one of ordinary skill in the art will readily recognize that there could be variations to the embodiment and these variations would be within the spirit and scope of the present invention. Accordingly, many modifications may be made by one of ordinary skill in the art without departing from the spirit and scope of the appended claims.

What is claimed is:

1. An apparatus for facilitating the attachment of at least one component to a camera, the apparatus comprising:
an adapter having a first end portion and a second end portion; and
a ring connected to a second end portion of the adapter, wherein the ring is configured to receive at least one component associated with a camera, and further wherein the ring is configured to not extend beyond the second and portion of the adapter.

2. The apparatus of claim 1, wherein the at least one component is a lens.

3. The apparatus of claim 1, wherein the ring defines at least two holes at least partially through a surface thereof.

4. The apparatus of claim 3 further comprising a tool for tightening the ring in the adapter.

5. The apparatus of claim 4 wherein the tool for tightening the ring in the adapter includes at least two posts for engaging the at least two holes to facilitate tightening of the ring in the adapter.

6. The apparatus of claim one wherein the ring is threadably connected to the adapter.
